(19) United States
(12) Patent Application Publication
(10) Pub. No.: US 2010/0170950 A1
(43) Pub. Date: Jul. 8, 2010

(54) INFORMATION CODE READING DEVICE AND READING METHOD, AND INFORMATION CODE DISPLAY READING SYSTEM

(75) Inventors: Tomoaki Iwai, Saitama (JP); Manabu Nohara, Saitama (JP); Takayuki Akimoto, Saitama (JP); Yusuke Soga, Saitama (JP); Ryoji Noguchi, Saitama (JP)

Correspondence Address: DRINKER BIDDLE & REATH (DC), 1500 K STREET, N.W., SUITE 1100, WASHINGTON, DC, 20005-1209, US

(73) Assignee: PIONEER CORPORATION, Tokyo (JP)

(21) Appl. No.: 12/294,677

(22) PCT Filed: Mar. 27, 2007
(86) PCT No.: PCT/JP2007/056372

§ 371 Date: Oct. 16, 2008

(30) Foreign Application Priority Data
Mar. 27, 2006 (JP) 2006-084373

(51) Int. Cl. G06K 7/10

(52) U.S. Cl. 235/454

(57) ABSTRACT

It is an object to provide a reading apparatus of an information code, a reading method, and a display reading system of the information code, in which even if symbol areas serving as references when sampling a photograph image signal obtained by photographing a display screen are not provided in the information code, information code data representing the information code can be obtained from the photograph image signal. When reading the information code displayed on a display apparatus, first, an image signal obtained when all pixel cells of the display apparatus have emitted light is extracted as a first image signal from the photograph image signal obtained by photographing the display screen of the display apparatus. Further, an image signal obtained for a period of time during which the information code is displayed is extracted as a second image signal from the photograph image signal. By detecting a point of a center of gravity of the light emission of each of the pixel cells based on the first photograph image signal and sampling the second photograph image signal at the point of the center of gravity of the light emission, the information code data representing the information code is obtained.

### TECHNICAL FIELD

The invention relates to a reading apparatus for reading an information code displayed on a display, a reading method of the information code, and a display reading system of the information code.

### BACKGROUND ART

Nowadays, an information code such as bar code as a 1-dimensional code or QR (Quick Response) code as a 2-dimensional code is used. In recent years, a system has been proposed in which information data is converted into a QR code, the QR code is displayed onto a display of a cellular phone or the like, and the displayed QR code is photographed and read, thereby obtaining the information data (for example, refer to FIG. 1 of Patent Document 1).

In this case, in order to accurately extract an area corresponding to the QR code from a photograph image signal obtained by photographing the QR code, it is necessary to sample the photograph image signal at each of proper coordinates position in which a position of a center of gravity of the QR code is used as a reference. In the QR code, therefore, a cutting symbol is provided for each of three corners of each QR code area so that a reference point of the sampling corresponding to the position of the center of gravity can be obtained on a reading apparatus side. In the case of photographing and reading the 2-dimensional information code such as a QR code, therefore, it is necessary to provide the symbols serving as reference points of the sampling into the area of the 2-dimensional information code. There is, consequently, such a problem that an information amount of the 2-dimensional information code which can be expressed per unit area is reduced by an amount corresponding to the area where the symbol is displayed.

Patent Document 1: Japanese Patent Kokai No. 2002-109421

### DISCLOSURE OF INVENTION

### Problem to be solved by the Invention

It is an object of the invention to provide a reading apparatus of an information code, a reading method, and a display reading system of the information code, in which even if symbol areas serving as references when sampling a photograph image signal obtained by photographing a display screen are not provided in the information code, information code data representing the information code can be obtained from the photograph image signal.

### Means for Solving the Problem

According to the invention, there is provided a reading apparatus for reading an information code displayed on a display apparatus for displaying the information code, comprising: means for obtaining a photograph image signal by photographing a display screen of the display apparatus; first photograph image extracting means for extracting an image signal, as a first image signal, obtained from the photograph image signal when all pixel cells of the display apparatus have emitted light; second photograph image extracting means for extracting an image signal, as a second image signal, obtained from the photograph image signal within a period of time during which the information code is displayed; and sampling means for detecting a point of a center of gravity of the light emission of each of the pixel cells based on the first photograph image signal and sampling the second photograph image signal at the point of the center of gravity of the light emission, thereby obtaining information code data representing the information code.

According to the invention, there is also provided a reading method of reading an information code displayed on a display apparatus for displaying the information code, comprising: a step of obtaining a photograph image signal by photographing a display screen of the display apparatus; a first photograph image extracting step of extracting an image signal, as a first image signal, obtained from the photograph image signal when all pixel cells of the display apparatus have emitted light; a second photograph image extracting step of extracting an image signal, as a second image signal, obtained from the photograph image signal within a period of time during which the information code is displayed; and a sampling step of detecting a point of a center of gravity of the light emission of each of the pixel cells based on the first photograph image signal and sampling the second photograph image signal at the point of the center of gravity of the light emission, thereby obtaining information code data representing the information code.

According to the invention, there is provided a display reading system of an information code, comprising a display apparatus for displaying the information code and a reading apparatus for reading the information code displayed on the display apparatus, wherein the display apparatus has means for allowing all pixel cells to emit light for a predetermined first period of time within a unit display period of time and allowing each of the pixel cells to emit the light for a predetermined second period of time within the unit display period of time in accordance with a light emission pattern corresponding to the information code, and the reading apparatus has: means for obtaining a photograph image signal by photographing a display screen of the display apparatus; first photograph image extracting means for extracting an image signal, as a first image signal, corresponding to the light emission of each of the pixel cells for the first period of time from the photograph image signal; second photograph image extracting means for extracting an image signal, as a second image signal, corresponding to the light emission of each of the pixel cells for the second period of time from the photograph image signal; and sampling means for detecting a point of a center of gravity of the light emission of each of the pixel cells based on the first photograph image signal and sampling the second photograph image signal at the point of the center of gravity of the light emission, thereby obtaining information code data representing the information code.

### ADVANTAGES OF THE INVENTION

According to the invention, even if the symbol area for sampling the photograph image signal obtained by photographing the information code displayed on the display is not provided in the information code, the photograph image signal is sampled at the proper sampling point and the data showing the information code can be obtained.

### BRIEF DESCRIPTION OF DRAWINGS

FIG. 1 is a diagram showing a schematic construction of an electronic blackboard as a display reading system of an information code based on the invention.

FIG. 2 is a diagram showing a part of a layout of pixel cells P and pixel blocks PB in a PDP 100 shown in FIG. 1.

FIG. 3 is a diagram showing an example of a light emission driving sequence at the time of driving the PDP 100.

FIG. 4 is a diagram showing a light emission pattern in the case where a main image display driving step (subfields SF1 to SF8) has been executed in accordance with a light emission driving sequence shown in FIG. 3.

FIG. 5 is a diagrams showing examples of blackboard images which are displayed on the PDP 100.

FIG. 6 is a diagram showing an internal construction of an electronic chalk 9 as a reading apparatus of the information code according to the invention.

FIG. 7 is a diagram showing an example of an internal construction of a frame sync detecting circuit 93 shown in FIG. 6.

FIG. 8 is a diagram schematically showing a positional relation between the pixel cells P when seen from a display screen of the PDP 100 and a unit image pickup cells XC of an image sensor 91.

FIG. 9 is a diagram showing an internal construction of an image processing circuit 94 shown in FIG. 6.

FIG. 10 is a diagram for explaining the operations of a reset photograph image extracting circuit 943 and a sampling point detecting circuit 945 shown in FIG. 9.

### DESCRIPTION OF REFERENCE NUMERALS

9. Electronic chalk
91. Image sensor
92. Noise sensor
944. 2-dimensional code photograph image extracting circuit
945. Sampling point detecting circuit
946. Sampling circuit
100. Plasma display panel

### BEST MODE FOR CARRYING OUT THE INVENTION

When reading an information code displayed on a display apparatus, first, an image signal obtained when all pixel cells of the display apparatus have emitted light is extracted, as a first image signal, from a photograph image signal obtained by photographing a display screen of the display apparatus. Further, an image signal obtained for a period of time during which the information code has been displayed is extracted, as a second image signal, from the photograph image signal. A point of a center of gravity of the light emission of each pixel cell is detected based on the first photograph image signal and the second photograph image signal is sampled at the point of the center of gravity of the light emission, thereby obtaining information code data representing the information code.

### Embodiment

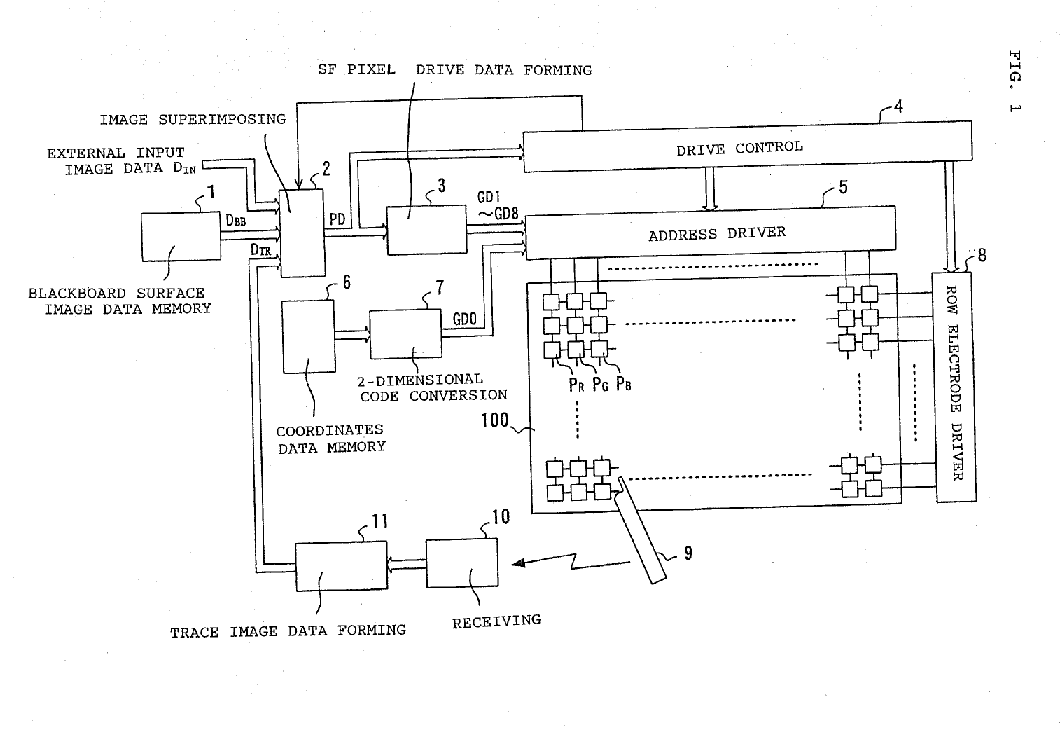

FIG. 1 is a diagram showing a construction of an electronic blackboard as a display reading system of the information code according to the invention.

In FIG. 1, a plasma display panel 100 (hereinbelow, referred to as a PDP 100) serving as an electronic blackboard main body has: a transparent front substrate (not shown) serving as a blackboard surface; and a rear substrate (not shown). A discharge space in which a discharge gas has been sealed exists between the front substrate and the rear substrate. A plurality of row electrodes each extending in the horizontal direction (lateral direction) of the display surface have been formed on the front substrate. A plurality of column electrodes each extending in the vertical direction (longitudinal direction) of the display surface have been formed on the rear substrate. A pixel cell has been formed in a crossing portion (including the discharge space) of each row electrode and each column electrode. As shown in FIG. 1, each pixel cell is constructed by three kinds of pixel cells: a pixel cell P_{R} which emits light in red; a pixel cell P_{G} which emits light in green; and a pixel cell P_{B} which emits light in blue.

Blackboard surface image data showing a blackboard surface (for example, all in black) to be displayed on the whole display screen of the PDP 100 has previously been stored in a blackboard surface image data memory 1. The blackboard surface image data memory 1 sequentially reads out the blackboard surface image data and supplies it as blackboard surface image data D_{BB} to an image superimposing circuit 2.

The image superimposing circuit 2 forms pixel data PD in which an image obtained by superimposing a blackboard surface image shown by the blackboard surface image data D_{BB}, an image shown by an external input image data signal D_{IN}, and an image shown by a trace image data signal D_{TR} (which will be explained hereinafter) is shown every pixel cell P and supplies it to each of an SF pixel drive data forming circuit 3 and a drive control circuit 4. If a blackboard display cancel signal is supplied from the drive control circuit 4 (which will be explained hereinafter), the image superimposing circuit 2 supplies the pixel data PD in which an image obtained by superimposing the image shown by the external input image data signal D_{IN} and the image shown by the trace image data signal D_{TR} is shown every pixel cell P to each of the SF pixel drive data forming circuit 3 and the drive control circuit 4.

The SF pixel drive data forming circuit 3 forms pixel drive data GD1 to GD8 for setting a state of each pixel cell P into either a light-on mode or a light-off mode in each of subfields SF1 to SF8 (which will be explained hereinafter) every pixel data PD in accordance with a luminance level shown by the pixel data PD and supplies them to an address driver 5.

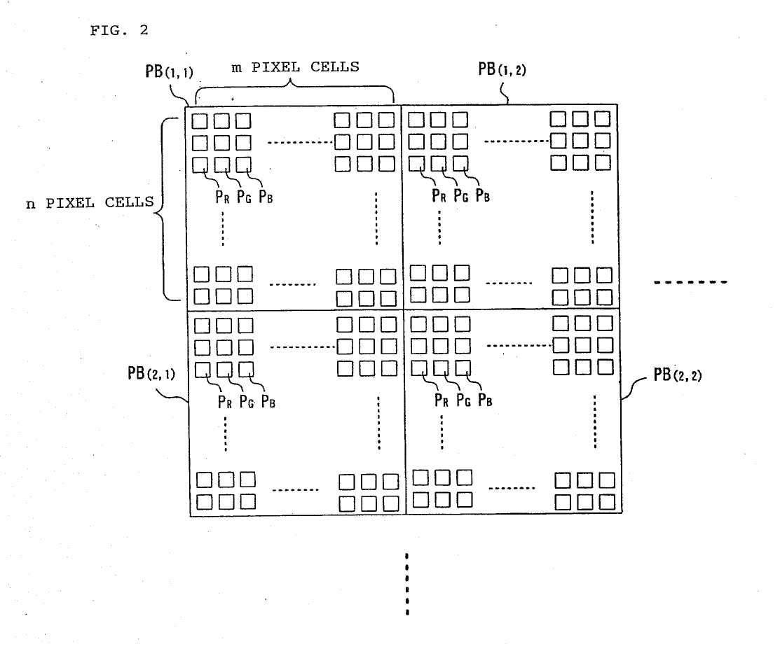

Every pixel block constructed by a plurality of adjacent pixel cells P, coordinates data showing a coordinates position in the display screen of the PDP 100 where the pixel block is located has previously been stored in a coordinates data memory 6. For example, every pixel block PB (area surrounded by a bold frame) constructed by the pixel cells P of n rows×m columns as shown in FIG. 2, the coordinates data showing the coordinates position in the display screen of the PDP 100 in the pixel block PB has been stored in the coordinates data memory 6 in correspondence to the pixel block PB. The coordinates data memory 6 reads out the coordinates data and supplies to a 2-dimensional code converting circuit 7.

First, the 2-dimensional code converting circuit 7 converts the coordinates data corresponding to each pixel block PB into a 2-dimensional code of (n×m) bits. The 2-dimensional code converting circuit 7 makes each bit of the 2-dimensional code correspond to each of the (n×m) pixel cells P in the pixel block PB and supplies the bit corresponding to each pixel cell P as pixel drive data GD0 corresponding to the pixel cell P to the address driver 5.

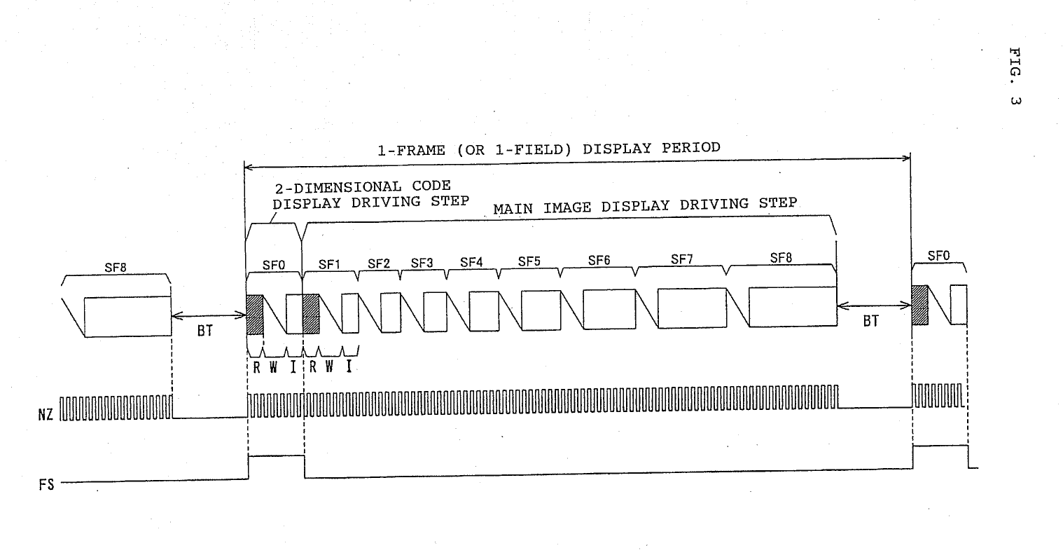

The drive control circuit 4 sequentially executes a 2-dimensional code display driving step and a main image display driving step within a display period of time of one frame (or one field) based on a light emission driving sequence shown in FIG. 3 based on a subfield method. In this instance, in the main image display driving step, the drive control circuit 4 sequentially executes an addressing step W and a sustaining step I in each of the eight subfields SF1 to SF8 as shown in FIG. 3. Only in the subfield SF1, prior to the addressing step W, the drive control circuit 4 executes a resetting step R. In the 2-dimensional code display driving step, the drive control circuit 4 sequentially executes the resetting step R, addressing step W, and sustaining step I in a subfield SF0 as shown in FIG. 3. A blanking period BT having a predetermined period duration is provided after the main image display driving step.

By executing each of the resetting step R, addressing step W, and sustaining step I, the drive control circuit 4 generates various control signals for driving the PDP 100 as shown below and supplies them to each of the address driver 5 and a row electrode driver 8.

In this process, by the execution of the resetting step R, the row electrode driver 8 applies resetting pulses to all row electrodes of the PDP 100 so as to initialize states of all of the pixel cells P of the PDP 100 to a state of the light-on mode.

Subsequently, by the execution of the addressing step W, the address driver 5 generates a pixel data pulse having a voltage according to pixel drive data GD corresponding to a subfield SF to which the addressing step W belongs. That is, for example, in the addressing step W of the subfield SF1, the address driver 5 generates the pixel data pulse according to the pixel drive data GD1. In the addressing step W of the subfield SF2, the address driver 5 generates the pixel data pulse according to the pixel drive data GD2. In this instance, for example, if the pixel drive data GD showing that the pixel cells P are set into the state of the light-on mode have been supplied, the address driver 5 generates the pixel data pulse of a high voltage. If the pixel drive data GD showing that the pixel cells P are set into the state of the light-off mode have been supplied, the address driver 5 generates the pixel data pulse of a low voltage.

For such a period of time, the row electrode driver 8 sequentially applies a scanning pulse to each of the row electrodes of the PDP 100 synchronously with applying timing of the pixel data pulse group of every display line. Owing to the above operation, each of the pixel cells P of the number corresponding to one display line belonging to the row electrodes to which the scanning pulses have been applied is set into the state (light-on mode or light-off mode) responsive to the pixel data pulse.

Subsequently, by the execution of the sustaining step I, the row electrode driver 8 applies sustaining pulses to all of the row electrodes of the PDP 100 so as to allow only the pixel cells P which are in the light-on mode state to repetitively execute a discharge light emission for the light emitting period of time allocated to the subfields SF to which the sustaining step I belongs. In the embodiment shown in FIG. 3, the minimum light emitting period of time has been allocated to the subfield SF0.

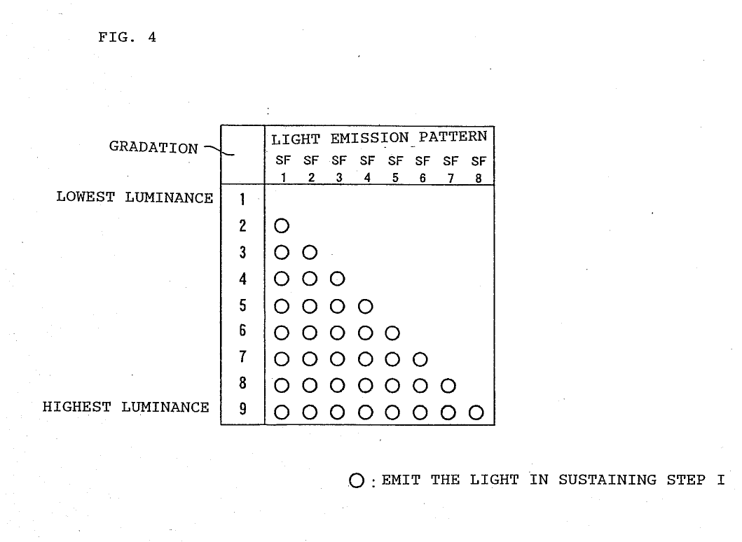

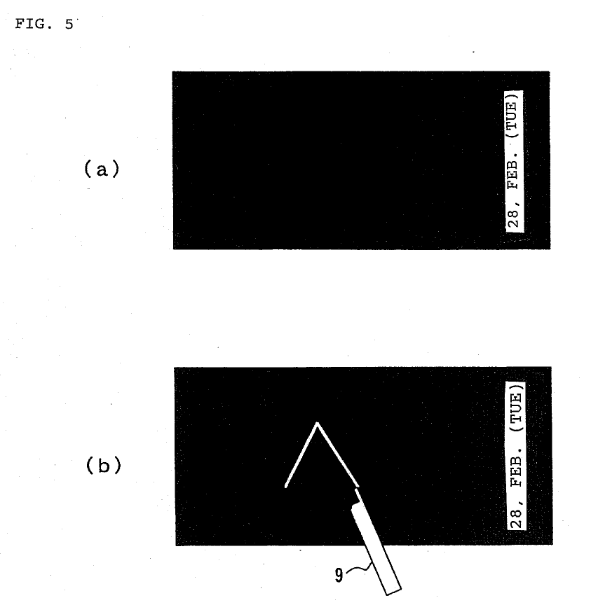

By the execution of the main image display driving step (subfields SF1 to SF8) as shown in FIG. 3, in accordance with the pixel drive data GD1 to GD8 based on the pixel data PD, the light emission of the pixel cells P is executed in the sustaining step I of each of the continuous subfields SF (shown by white circles) subsequent to the subfield SF1 as shown in FIG. 4. That is, the light emission of the pixel cells P is executed based on any one of eight kinds of light emission patterns as shown in FIG. 4 in accordance with a luminance level shown by the pixel data PD. In this instance, an intermediate luminance corresponding to the total light emitting period of time within the 1-frame display period of time is visually perceived. That is, according to the eight kinds of light emission patterns as shown in FIG. 4, intermediate luminances as many as what are called nine gradations in which the luminance level shown by the pixel data PD is expressed by nine levels. According to the pixel data PD formed based on the blackboard surface image data D_{BB} showing the blackboard surface (for example, all in black), an image showing a blackboard surface as shown in, for example, FIG. 5(a) is displayed on the whole display screen of the PDP 100.

By the execution of the 2-dimensional code display driving step (subfield SF0) as shown in FIG. 3, the light emission of each pixel cell P is executed in the sustaining step I of the subfield SF0 in accordance with the pixel drive data GD0 based on the coordinates data. That is, a light-on pattern and a light-off pattern based on a 2-dimensional code showing the coordinates position of each of the pixel blocks PB as shown in FIG. 2 are formed on the coordinates positions of the pixel blocks PB, respectively. For example, in FIG. 2, in each of the (n×m) pixel cells P belonging to a pixel block PB(_{1,1}) locating on the first row and the first column in the display screen of the PDP 100, the light emission is executed by the light-on pattern and the light-off pattern showing the first row and the first column. In FIG. 2, in each of the (n×m) pixel cells P belonging to a pixel block PB(_{2,1}) locating on the second row and the first column, the light emission is executed by the light-on pattern and the light-off pattern showing the second row and the first column. The light emitting period of time allocated to the sustaining step I of the subfield SF0 as mentioned above is set to such a short period of time that the light-on pattern and the light-off pattern based on the 2-dimensional code cannot be visually perceived.

An electronic chalk 9 serving as a reading apparatus of an information code according to the invention extracts the light-on and light-off patterns based on the 2-dimensional code from the photograph image signal obtained by photographing the display screen of the PDP 100 on a unit basis of the pixel block PB as shown in FIG. 2 and transmits a coordinates signal showing the coordinates position corresponding to the light-on and light-off patterns in a wireless manner.

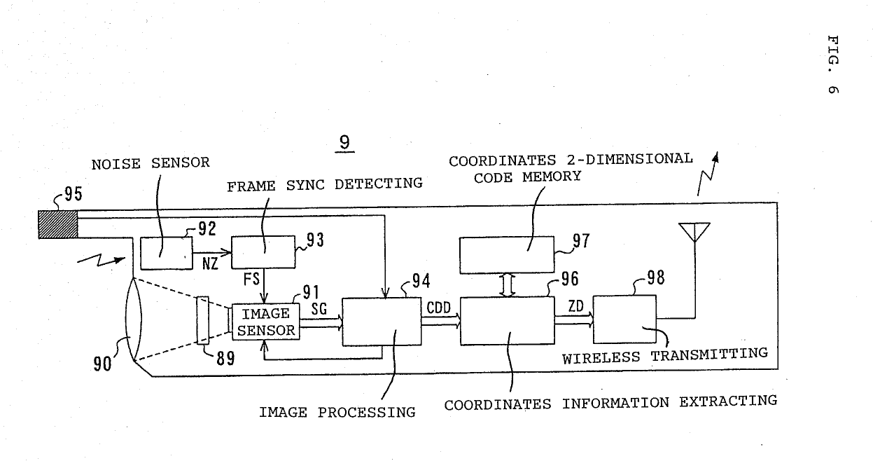

FIG. 6 is a diagram showing an example of an internal construction of the electronic chalk 9.

In FIG. 6, an objective lens 90 fetches the display light irradiated from the display screen of the PDP 100 on a unit basis of the area of each pixel block PB and transfers it to an image sensor 91 through an optical filter 89 for cutting the red and green components.

A noise sensor 92 generates a pulse-like noise detection signal NZ which is set to a logic level “1” when noises emitted from the display screen of the PDP 100 in association with a discharge that is caused in each pixel cell P in the PDP 100 are detected, that is, when the irradiation of infrared rays, ultraviolet rays, or electromagnetic waves is detected and supplies it to a frame sync detecting circuit 93. In this process, since various kinds of discharge are caused during the execution periods of time of the subfields SF0 to SF8 in the 1-frame (or 1-field) display period of time, each time the discharge is caused, the pulse-like noise detection signal NZ which is set to the logic level “1” as shown in FIG. 3 is formed. Since no discharge is caused for the blanking period BT after the end of the subfield SF8, the noise detection signal NZ is set to a logic level “0” for such a period of time as shown in FIG. 3.

In response to the noise detection signal NZ, the frame sync detecting circuit 93 forms a frame sync signal FS which is set to the logic level “1” during the execution period of time of the 2-dimensional code display driving step (subfield SF0) shown in FIG. 3 and to the logic level “0” for other periods of time and supplies it to the image sensor 91.

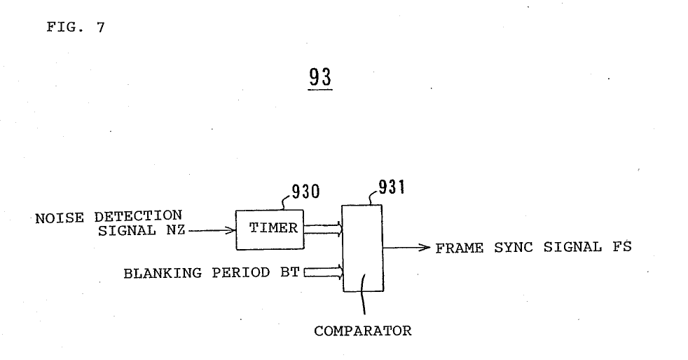

FIG. 7 is a diagram showing an example of an internal construction of the frame sync detecting circuit 93.

In FIG. 7, a timer 930 counts the number of pulses of a clock signal (not shown) of a predetermined frequency from an initial value 0 and supplies an elapsed time signal showing an elapsed time corresponding to a count value to a comparator 931. When the time shown by the elapsed time signal coincides with the blanking period BT as shown in FIG. 3, the comparator 931 forms the frame sync signal FS as shown in FIG. 3 which is set to the logic level “1” for a time interval spent for the execution of the subfield SF0.

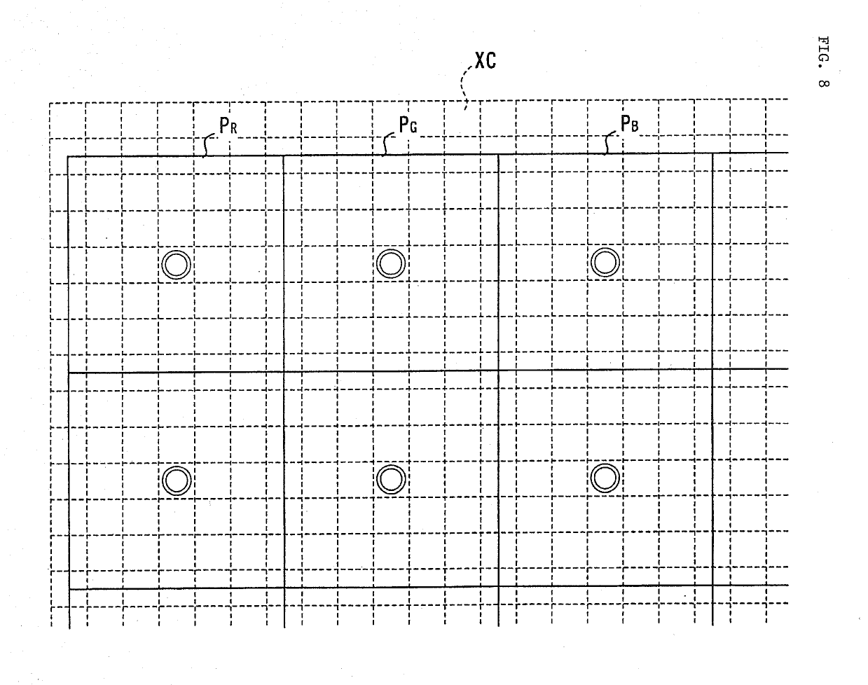

As shown in FIG. 8, the image sensor 91 has an image pickup surface on which a plurality of unit image pickup cells XC (areas surrounded by broken lines) for converting the received light into a photoelectric conversion signal having a signal level corresponding to a light intensity of the received light have been arranged. In FIG. 8, an area surrounded by solid lines indicates an area of each of the pixel cells P. Only for a period of time during which the frame sync signal FS of the logic level “1” as shown in FIG. 3 is supplied, the image sensor 91 allows the display light supplied from the objective lens 90 to be received onto the image pickup surface. At this time, the image sensor 91 supplies a photograph image signal SG showing a level of each photoelectric conversion signal obtained every unit image pickup cells XC to an image processing circuit 94.

That is, the image sensor 91 supplies the photograph image signal SG showing the image obtained by superimposing the emission light corresponding to the 2-dimensional code (showing the coordinates position of the pixel block PB) associated with the discharge caused in the pixel cell P in the sustaining step I of the subfield SF0 in FIG. 3 to the emission light associated with the resetting discharge caused in all of the pixel cells P in the resetting step R of the subfield SF0 in FIG. 3 to the image processing circuit 94. At this time, the image sensor 91 executes a contrast adjusting process to the photograph image signal SG in accordance with an offset signal supplied from the image processing circuit 94.

For a period of time during which a front edge portion is pressed onto the display screen of the PDP 100, a pen pressure sensor 95 attached to the front edge portion of the electronic chalk 9 forms a drawing execution signal showing that the drawing onto the blackboard surface is being executed and supplies it to the image processing circuit 94.

Only for a period of time during which the drawing execution signal is supplied, the image processing circuit 94 fetches the photograph image signal SG supplied from the image sensor 91. At this time, when the luminance level shown by the photograph image signal SG is deviated to the luminance side higher than a predetermined luminance, the image processing circuit 94 determines that the external light is strong, and supplies the offset signal to the image sensor 91 so as to suppress the external light. The image processing circuit 94 further samples only the signal level obtained at the point of the center of gravity of the light emission of each pixel cell P from the photograph image signal SG and supplies a data series based on sampled values as 2-dimensional code data CDD to a coordinates information extracting circuit 96.

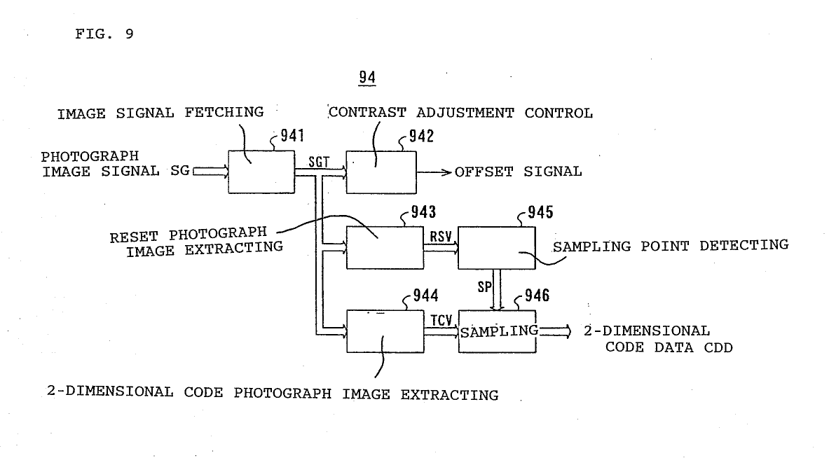

FIG. 9 is a diagram showing an internal construction of the image processing circuit 94.

In FIG. 9, only for a period of time during which the drawing execution signal is supplied, an image signal fetching circuit 941 fetches the photograph image signal SG supplied from the image sensor 91 and supplies it as a photograph image signal SGT to a contrast adjustment control circuit 942, a reset photograph image extracting circuit 943, and a 2-dimensional code photograph image extracting circuit 944, respectively. When the luminance level shown by the photograph image signal SGT is deviated to the luminance higher than the predetermined luminance, the contrast adjustment control circuit 942 determines that the external light is strong, and supplies the offset signal to the image sensor 91 so as to suppress the external light. At this time, in accordance with the offset signal, the image sensor 91 forms the photograph image signal SG adjusted to the contrast adapted to enable an optimum process to be executed in a processing circuit at the post stage as will be explained hereinafter.

The reset photograph image extracting circuit 943 extracts a reset photograph image based on the light emission associated with the resetting discharge caused in the resetting step R of the subfield SF0 shown in FIG. 3 from the photograph image signal SGT and supplies a reset photograph image signal RSV showing it to a sampling point detecting circuit 945. That is, first, the reset photograph image extracting circuit 943 compares the signal level shown by the photograph image signal SGT with a predetermined first level L1 every unit image pickup cell XC as shown in FIG. 8. The first level L1 denotes a threshold value for detecting the weak light emission associated with the resetting discharge. The reset photograph image extracting circuit 943 forms the reset photograph image signal RSV which shows, every unit image pickup cell XC, the light-on state when the signal level shown by the photograph image signal SGT is higher than the first level L1 and light-off state when the signal level is lower than the first level L1 and supplies to the sampling point detecting circuit 945.

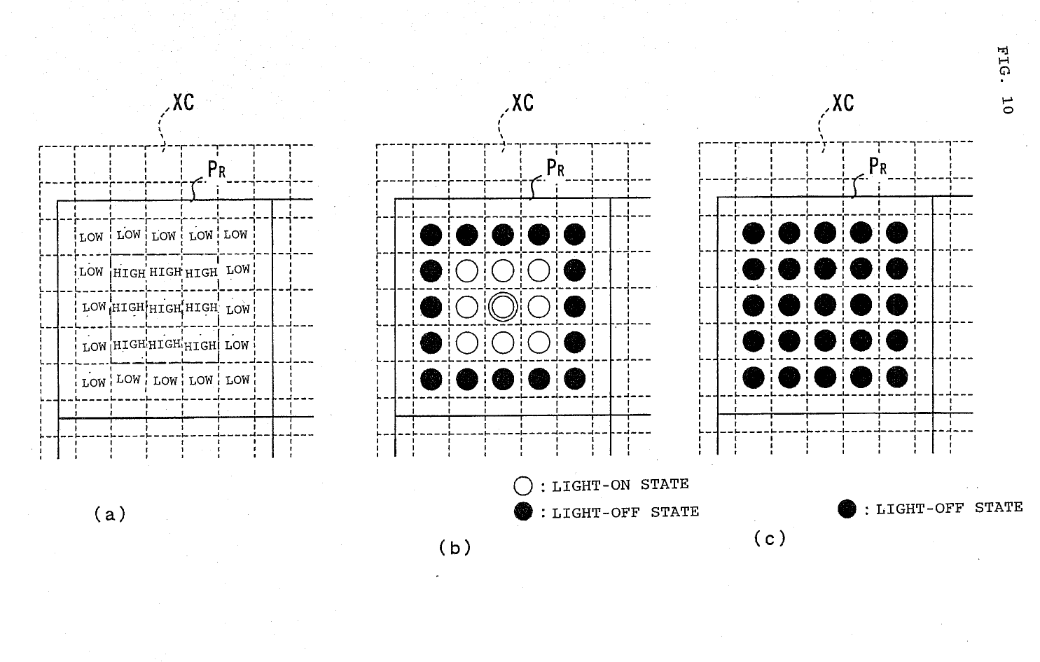

That is, according to the execution of the resetting step R, although the weak resetting discharge is caused in all of the pixel cells P, actually, the resetting discharge is caused only in a partial area in the pixel cell P and, in each pixel cell P, the more the position is away from the partial area, the more the light emission intensity associated with the discharge deteriorates. When the discharge is caused in, for example, a center portion of the pixel cell P, therefore, as shown in FIG. 10(a), all of the levels of the photograph image signals SGT obtained in the unit image pickup cell XC which receives the emission light from the center portion of the pixel cell P and the eight unit image pickup cells XC adjacent to a periphery of the unit image pickup cell XC are higher than the first level L1. The level of the photograph image signal SGT obtained in each unit image pickup cell XC which receives the emission light associated with the discharge in the portion away from the center portion of the discharge in the pixel cell P, however, is lower than the first level L1. As shown in FIG. 10(b), therefore, every unit image pickup cell XC, the reset photograph image extracting circuit 943 supplies the reset photograph image signal RSV showing in such a manner that the cell XC in which the signal level of the photograph image signal SGT is higher than the first level L1 is made to correspond to the light-on state (shown by the white circle) and the cell XC in which the signal level is lower than the first level L1 is made to correspond to the light-off state (shown by a black circle) to the sampling point detecting circuit 945.

On the basis of the reset photograph image signal RSV, every pixel cell P, the sampling point detecting circuit 945 selects the unit image pickup cell XC locating at the point of the center of gravity of the light emission from a plurality of unit image pickup cells XC each for receiving the emission light from the pixel cell P and supplies a sampling point signal SP showing its coordinates position as a sampling point to a sampling circuit 946. That is, the sampling point detecting circuit 945 detects a position of a center of gravity of a block constructed by a plurality of unit image pickup cells XC corresponding to the light-on state (shown by the white circles) as shown in FIG. 10(b) and detects a coordinates position, as a sampling point, of the unit image pickup cell XC existing at the position of a center of gravity. For example, in each unit image pickup cell XC for receiving the emission light from the pixel cell P in the state as shown in FIG. 10(b), since the unit image pickup cell XC shown by a symbol of double white circles is located at the center of gravity of the light emission, the sampling point detecting circuit 945 forms the sampling point signal SP showing the coordinates position of the unit image pickup cell XC shown by the symbol of the double white circles.

In this manner, the sampling point detecting circuit 945 detects the point of the center of gravity of the light emission of each pixel cell P based on the reset photograph image signal RSV and supplies the sampling point signal SP showing the point of the center of gravity of the light emission as a sampling point to the sampling circuit 946.

The 2-dimensional code photograph image extracting circuit 944 extracts a 2-dimensional code photograph image based on the light emission associated with the discharge caused in the sustaining step I of the subfield SF0 shown in FIG. 3 from the photograph image signal SGT and supplies a 2-dimensional code photograph image signal TCV showing it to the sampling circuit 946. That is, first, the 2-dimensional code photograph image extracting circuit 944 compares the signal level shown by the photograph image signal SGT with a predetermined second level L2 every unit image pickup cell XC as shown in FIG. 8. The second level L2 denotes a threshold value for detecting the light emission associated with the discharge in the sustaining step I whose luminance is higher than that of the light emission associated with the resetting discharge. The 2-dimensional code photograph image extracting circuit 944 forms the 2-dimensional code photograph image signal TCV showing, every unit image pickup cell XC, that when the signal level shown by the photograph image signal SGT is higher than the second level L2, the cell XC is in the light-on state, and when the signal level is lower than the second level L2, the cell XC is in the light-off state and supplies it to the sampling circuit 946.

That is, according to the execution of the sustaining step I in the 2-dimensional code display driving step as shown in FIG. 3, the discharge light emission corresponding to the 2-dimensional code showing the coordinates position of each pixel block PB is executed in each pixel cell P. In this instance, in each unit image pickup cell XC for photographing the light emitted from the pixel cell P in the light-on state, all of the levels of the photograph image signals SGT obtained in the unit image pickup cells XC each locating near the center portion of the pixel cell P as shown in FIG. 10(a) is higher than the second level L2. In the pixel cell P, however, the level of the photograph image signal SGT obtained in each unit image pickup cell XC which receives the light from an area away from the center portion of the discharge is lower than the second level L2. All of the levels of the photograph image signals SGT obtained in the unit image pickup cells XC each for photographing the light emitted from the pixel cell P in the light-off state are lower than the second level L2. Every unit image pickup cell XC as shown in FIG. 10(b) or FIG. 10(c), the 2-dimensional code photograph image extracting circuit 944, therefore, supplies the 2-dimensional code photograph image signal TCV showing that when the signal level of the photograph image signal SGT is higher than the second level L2, the cell XC is made to correspond to the light-on state (shown by white circle), and when the signal level is lower than the second level L2, the cell XC is made to correspond to the light-off state (shown by black circle) to the sampling point detecting circuit 945.

The sampling circuit 946 samples only the value of the photograph image signal obtained at the sampling point shown by the sampling point signal SP, that is, at the point of the center of gravity of the light emission (shown by, for example, the symbol of the double circles in FIG. 8) of each pixel cell P from the 2-dimensional code photograph image signal TCV. The sampling circuit 946 supplies a data series based on sampled values as 2-dimensional code data CDD showing the 2-dimensional code to the coordinates information extracting circuit 96 shown in FIG. 6.

Coordinates data showing the coordinates position in the display screen of the PDP 100 of each of the pixel blocks PB as shown in FIG. 2 and the 2-dimensional code obtained by converting the coordinates data into the 2-dimensional code on a pixel block PB unit basis have preliminarily been stored in a coordinates 2-dimensional code memory 97 in correspondence to each other.

First, the coordinates information extracting circuit 96 reads out the coordinates data corresponding to the 2-dimensional code shown by the 2-dimensional code data CDD supplied from the image processing circuit 94 from the coordinates 2-dimensional code memory 97 and supplies it as coordinates data ZD to a wireless transmitting circuit 98. The wireless transmitting circuit 98 executes a modulating process to the coordinates data ZD and transmits it in a wireless manner.

A receiving circuit 10 shown in FIG. 1 receives a transmission wave from the electronic chalk 9 and demodulates it, thereby reconstructing the coordinates data ZD and supplying to a trace image data forming circuit 11. The trace image data forming circuit 11 forms image data showing a straight line or a curve which sequentially traces the coordinates positions shown by the coordinates data ZD which is sequentially supplied from the receiving circuit 10 and supplies it as a trace image data signal D_{TR} to the image superimposing circuit 2. The driving based on the main image display driving step constructed by the subfields SF1 to SF8 as shown in FIG. 3 is, consequently, executed in accordance with the pixel data PD obtained by superimposing the trace image data signal D_{TR} to the blackboard surface image data D_{BB}. At this time, when the front edge portion of the electronic chalk 9 is moved while the front edge portion is come into contact with the display screen of the PDP 100, an image of the straight line or curve along its movement locus is superimposed and displayed into the blackboard surface image shown by the blackboard surface image data D_{BB} as shown in FIG. 5(b).

As mentioned above, the electronic chalk 9 obtains the 2-dimensional code data (CDD) showing the 2-dimensional code from the photograph image signal (SG or SGT) obtained by photographing the display screen of the PDP 100 for the display period of time (SF0) of the 2-dimensional code showing the coordinates position information (ZD). At this time, when obtaining the 2-dimensional code data from the photograph image signal, first, the image processing circuit 94 of the electronic chalk 9 extracts the image signal (RSV) corresponding to the light emission associated with the resetting discharge from the photograph image signal. Subsequently, the image processing circuit 94 detects the point (SP) of the center of gravity of the light emission of each pixel cell P based on the image signal corresponding to the light emission associated with the resetting discharge. That is, in the plasma display panel, every pixel cell P, the point of the center of gravity of the light emission in the pixel cell P is detected by using the light emission associated with the resetting discharges which are simultaneously caused in all of the pixel cells. The image processing circuit 94 samples only the signal level corresponding to the point (SP) of the center of gravity of the light emission of each pixel cell P from the photograph image signal (SG or SGT), thereby obtaining the 2-dimensional code data (CDD) corresponding to the 2-dimensional code.

According to the above construction, therefore, even if the symbol areas serving as references when sampling the photograph image signal obtained by photographing the information code are not provided in the information code, the data series corresponding to the information code can be obtained by sampling the photograph image signal at the proper sampling points. According to the invention, consequently, the information code whose information capacity has been increased by omitting the symbol areas serving as references when sampling the photograph image signal can be used.

Although the plasma display panel (PDP 100) has been used as a display apparatus in the electronic blackboard shown in the embodiment, the invention is not limited to it. In brief, the invention can be applied to any display so long as a display which can drive by such a driving sequence that all pixel cells periodically and simultaneously emit light.

### INDUSTRIAL APPLICABILITY

In the system for obtaining the information code by photographing the information code displayed on the display, the information code in which the symbol areas to be sampled are not provided can be used.

1. A reading apparatus for reading an information code displayed on a display apparatus for displaying said information code, comprising:
means for obtaining a photograph image signal by photographing a display screen of said display apparatus;
first photograph image extracting means for extracting an image signal, as a first image signal, obtained from said photograph image signal when all pixel cells of said display apparatus have emitted light;
second photograph image extracting means for extracting an image signal, as a second image signal, obtained from said photograph image signal within a period of time during which said information code is displayed; and
sampling means for detecting a point of a center of gravity of the light emission of each of said pixel cells based on said first photograph image signal and sampling said second photograph image signal at said point of the center of gravity of the light emission, thereby obtaining information code data representing said information code.

2. A reading apparatus of the information code according to claim 1, wherein
said display apparatus is a plasma display apparatus in which every unit display period of time, in at least one of N (N is an integer of 2 or more) subfields, by executing a resetting step for allowing all of said pixel cells to simultaneously execute a resetting discharge, an addressing step for setting each of said pixel cells into either a light-on mode or a light-off mode in accordance with said information code, and a sustaining step for allowing only said pixel cells which have been set into said light-on mode to emit the light for a light emission period of time allocated to said subfield, an image display is executed, and
said first photograph image extracting means extracts the image signal, as a first image signal, corresponding to the light emission associated with said resetting discharge caused in each of said pixel cells from said photograph image signal.

3. A reading method of reading an information code displayed on a display apparatus for displaying the information code, comprising:
a step of obtaining a photograph image signal by photographing a display screen of said display apparatus;
a first photograph image extracting step of extracting an image signal, as a first image signal, obtained from said photograph image signal when all pixel cells of said display apparatus have emitted light;
a second photograph image extracting step of extracting an image signal, as a second image signal, obtained from said photograph image signal within a period of time during which said information code is displayed; and
a sampling step of detecting a point of a center of gravity of the light emission of each of said pixel cells based on said first photograph image signal and sampling said second photograph image signal at said point of the center of gravity of the light emission, thereby obtaining information code data representing said information code.

4. A display reading system of an information code, comprising a display apparatus for displaying the information code and a reading apparatus for reading said information code displayed on said display apparatus, wherein
said display apparatus has means for allowing all pixel cells to emit light for a predetermined first period of time within a unit display period of time and allowing each of said pixel cells to emit the light for a predetermined second period of time within said unit display period of time in accordance with a light emission pattern corresponding to said information code, and
said reading apparatus has:
means for obtaining a photograph image signal by photographing a display screen of said display apparatus;
first photograph image extracting means for extracting an image signal, as a first image signal, corresponding to the light emission of each of said pixel cells for said first period of time from said photograph image signal;
second photograph image extracting means for extracting an image signal, as a second image signal, corresponding to the light emission of each of said pixel cells for said second period of time from said photograph image signal; and
sampling means for detecting a point of a center of gravity of the light emission of each of said pixel cells based on said first photograph image signal and sampling said second photograph image signal at the point of the center of gravity of the light emission, thereby obtaining information code data representing said information code.

5. A display reading system of the information code, according to claim 4, wherein
said display apparatus is a plasma display apparatus which displays an intermediate luminance by each of N (N is an integer of 2 or more) subfields every unit display period of time,
said first period of time and said second period of time are included in at least one of said N subfields,
in said first period of time, said plasma display apparatus executes a resetting step for allowing all of said pixel cells to simultaneously execute a resetting discharge, and
in said second period of time, said plasma display apparatus executes an addressing step for setting each of said pixel cells into either a light-on mode or a light-off mode in accordance with said information code and a sustaining step for allowing only said pixel cells which have been set into said light-on mode to emit the light for a light emission period of time allocated to said subfield.
